(19) United States
(12) Patent Application Publication
(10) Pub. No.: US 2004/0056948 A1
(43) Pub. Date: Mar. 25, 2004

(54) Multi-play theatre

(76) Inventor: Robert John Gibson, Cary, NC (US)

Correspondence Address: Robert John Gibson, 308 Halls Mill Drive, Cary, NC, 27519, US

(21) Appl. No.: 10/252,215

(22) Filed: Sep. 23, 2002

(51) Int. Cl. H04N 13/04; H04N 9/47; H04N 15/00

(52) U.S. Cl. 348/56

(57) ABSTRACT

A method that enables multiple viewers to view one of several video streams simultaneously displayed on a single video display (or movie projection screen). Viewers can only view with shutter viewing glasses synchronized to the video stream they are viewing. This method also permits 3D viewing without modification of the video broadcast, video receiver technologies and minimal adaptation of existing 2D camera equipment. This method can also limit viewing access to permitted granted viewers only in the presence of non-granted viewers for security or privacy by encrypting the frame rate and generating masking video.

### SUMMARY OF INVENTION

A method that enables viewers to view one of several video streams being simultaneously displayed on a single video display (or movie projection screen). Viewers can only view by wearing shutter glasses synchronized to the video stream they are viewing. This method also permits 3D viewing without modification of the video broadcast, video receiver technologies and minimal adaptation of 2D movie camera equipment. For privacy this method can also limit viewing access to permitted viewers wearing glasses preventing viewing by non-granted viewers present and in the cases of high security masking video and frame rate encryption can be introduced.

### DETAILED DESCRIPTION

[Set Top Box Multi-View Mode]

The set top box receives two video inputs of the same frame rate, type and format. Every frame, from each of both video inputs is encoded and buffered in memory. At decoding the frames are base time synchronized to a common clock. After each frame the same clock switches output to the other decoder so that frames are output in an alternating pattern. While the combined streams equals the original frame rate, each video stream is played out at half its original frame rate. The output is played out at the same frame rate at the same video specifications required to display either of the original video inputs.

The associated audio is transmitted to earphones fitted in a pair of glasses worn by the viewer. The glasses have a electronic shutter that is synchronized to block the view of non-associated video but open to permit view of the video associated with the audio. Shutter synchronization of the glasses is sent from the set top box achieved via the signal associated with either the audio or the video display or a separate communications channel or as in the examples below an IRT infrared transmitter.

Should the buffering CODEC require decode and encoding of video in blocks of frames e.g. MPEG, the both audio and video will need to be encoding and decoding together to maintain synchronization.

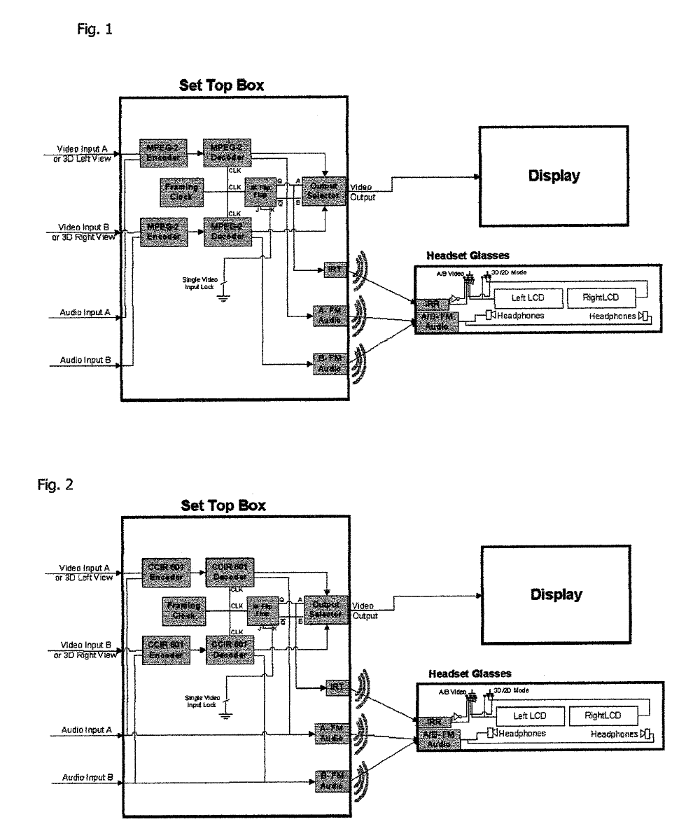

See “Block Diagram MPEG-2 CODECs” FIG. 1

However if video CODEC is performed on a frame by frame basis e.g. CCIR 601, then input audio can be passed directly through to output as the video would only incurs a small delay of approximately 100 ms ms through the CODEC effectively maintaining synchronization with the audio, but not perfectly synchronized. There is no need to buffer or modify audio to correct this, as the video delay is nearly imperceptible to the viewer.

See “Block Diagram CCIR 601 CODECs” FIG. 2

Set Top Box in 3D Mode

In 3D mode the glasses synchronize with the left eye video input and the right eye with right eye video input creating a 3D effect. This is achieved using existing standard video broadcast systems on existing standard receivers which distinguishes this patent from other 3D patents as there is no requirement to modify existing broadcast or receiver technologies and equipment, apart from the set top box and glasses described herein.

Limitations

It is anticipated that the shortcomings of the set top box will be most perceptible when viewing sports events. Viewing at half broadcast frame rate will at times result in jerky motion and there may be a possible perception of an audio delay. In such cases the set top box will include a bypassed to revert back to a single video stream at full frame rate. The limited capability of the set top box of just 2-video viewer inputs operating at half broadcast frame rate is intentional. It is intended to seed the market with inexpensive set top boxes to later precipitate demand for more expensive HDTV displays with further enhanced capabilities built in of more than 2 video inputs at full broadcast frame rate.

Inclusions & Exclusions

Set top box capabilities are permitted under this patent license to be incorporated in set top computer games consoles to permit the simultaneous viewing of: —*Computer games and one other video input.

Two Multi-player perspectives.

Two video inputs.

Single player 3D gaming.

Set top box patent license does not extend to and excludes incorporation within displays.

[Multi-Viewer Display]

The Multi-Viewer Display is the incorporation of the invention within the display unit.

Multi-View Mode:—All frames of from multiple video inputs are buffered, resynchronized and interleaved and into a single output stream that can be displayed on a single higher frame rate display than the video inputs.

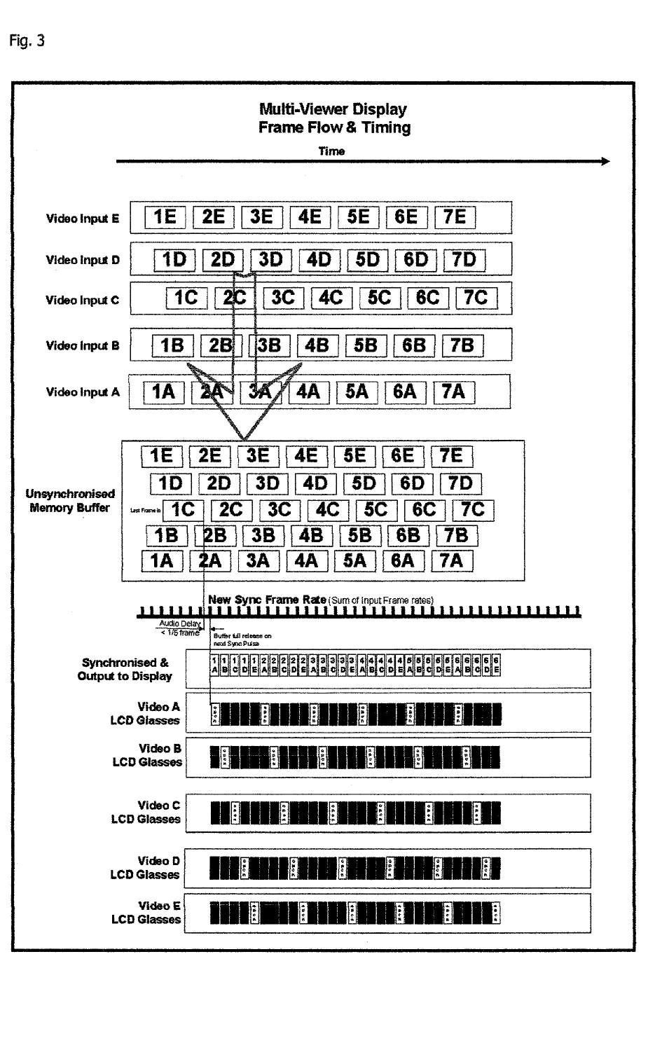

The associated audio is transmitted to an earphone in a pair of glasses worn by the viewer. These glasses have a shutter that is synchronized to block the view of non-associated video but open to permit view of the video associated with the audio. Each video input is viewed at the original frame rate since the display is capable of operating at multiples higher than the original frame rate each viewer. Shutter synchronization of the glasses is achieved via the signal associated with the audio, video display or separate channel. See FIG. 3 “Multi-Viewer Display Framing and Timing”

The buffering of each video stream for base time synchronizing results in a small delay of several frames before being output to the display. Audio will be buffered and synchronized with the associated video stream before output transmission to the earphone in the glasses.

Multi-View Display 3D Mode

In 3D mode the glasses synchronize with the left eye video input and the right eye with right eye video input creating a 3D effect. This patent is distinguished from other 3D patents in that this is achieved using existing standard video broadcast systems on existing standard receivers. There is no requirement to modify existing broadcast or receiver technologies and equipment, apart from the set top box and glasses described herein.

Inclusions & Exclusions

Due to the low refresh rates of CRTs is not intended to manufacture low definition multi-viewer displays, however patents right for CRT and any other display types is not wavered and shall be retained. Manufacture of multi-viewer displays shall be based on high definition television (HDTV) flat panel displays capable of higher brightness and high refresh rates than CRT based displays which is required to display more than 2 simultaneous views at full broadcast frame rate. It Is anticipated that HDTV flat panel displays should be capable of Interleaving at least five video inputs for viewing, which should significantly enhance sales of HDTV units. This market would be eroded if the same capabilities were permitted for low definition TV. It is intended to limit license of the patent to 16:9 HDTV format while retain patent rights for all other formats including 4:3 PAL/NTSC/SECAM low definition TV.

[High Security Displays]

High Security displays inject masking video and encrypt variations into the video frame rate and interleave pattern to provide high security displays that can only be viewed by permitted personnel with decrypting glasses.

Variations in frame rate and interleave pattern can be achieved by 1) modifying the display monitor with specialized hardware built into the display or 2) by specialized chipset built into the graphics adapter or 3) by computer software.

Viewers not wearing glasses view both synchronized and unsynchronized frames where the unsynchronized frames contain masking video that prevents viewing of the vie tram associated with the synchronized frames. Masking video of unsynchronized frames contain partial random pixels and inverted images of synchronized frames that effectively cancel out the synchronized images, the overall effect resulting in what is termed in the video industry as snow.

3D Mode is also available for high security displays with high frame refresh rates. Low frame refresh rate displays of 30 Hz or lower would not produce broadcast quality viewing, as each eyes frame rate would be approximately 10 frames per second.

Audio encryption is not claimed under this patent.

[Multi-View Theatre]

Frames from multiple films within a specially adapted film projector are interleaved projected onto a single screen at a frame rate that equals the sum of the frame rates of each film combined.

The associated audio is transmitted to an earphone in a pair of glasses worn by the viewer. These glasses have a shutter that is synchronized to block the view of non-associated film projection but open to permit view of the film projection associated with the audio. Each film projection is viewed at the original frame rate since the projector is capable of operating at the sum of the frame rate of the films combined. Shutter synchronization of the glasses is achieved via the signal associated with the audio, film projection or separate channel.

3D mode is claimed for films shot using two regular 2D film cameras on two separate reels suitable for 3D screening using this patent without further modifications to format.

1. What I claim as my invention is a method that permits the viewing of one of several video streams being simultaneously displayed on a single display using shutter glasses synchronized with the particular viewed video stream, that can also be operated in 3d mode to combine two left-right video streams from two separate broadcast channels to create a 3d illusion without in anyway degrading the existing 2d broadcast viewing:
What I claim as my invention is a method of video display that limits decoded interpretable viewing to permitted viewers wearing shutter glasses synchronized to a decrypted frame rate so that unauthorized viewers not wearing synchronized glasses are prevent from decoding the video and interpreting viewing by the injection of masking video into the unsynchronized frames and encrypted variations in the synchronized frame rate.
